(19) United States
(12) Patent Application Publication
(10) Pub. No.: US 2008/0300693 A1
(43) Pub. Date: Dec. 4, 2008

(54) Process Control System and Method

(76) Inventors: Sahid Abu-bakarr Sesay, Western Australia (AU); Martin John Peter Cebis, Western Australia (AU)

Correspondence Address: PAUL, HASTINGS, JANOFSKY & WALKER LLP, 875 15th Street, NW, Washington, DC, 20005, US

(21) Appl. No.: 11/661,261

(22) PCT Filed: Aug. 30, 2005
(86) PCT No.: PCT/AU05/01314

§ 371 Date: Jan. 18, 2008

(30) Foreign Application Priority Data
Aug. 30, 2004 (AU) 2004904902
Aug. 30, 2004 (AU) 2004904904

(51) Int. Cl. G05B 13/00

(52) U.S. Cl. 700/12

(57) ABSTRACT

An automated process control system (100) and method includes a controller (101) and a number of peripheral devices (104) that are controlled by the controller (101). The devices are located in a number of environments and sub-environments. The devices, environments, and sub-environments are organised in hierarchies and each device has an associated hierarchical identifier, which depends upon the environment in which the device is located. If the environment changes then so does the associated identifier. The controller is operable to determine when an environment changes and to implement any control actions that may be required by the change in the environment. The identifier for devices can also be linked to users of the system to define dependencies between the devices and users. Properties for the devices can therefore be linked to the users through the identifier, thus enabling multiple users to access the same devices.

### FIELD OF THE INVENTION

The present invention relates to a process control system and method for managing an automation system, particularly, although not exclusively for managing an automation system provided in an environment such as an office or workplace. Such a system provides for the logging of data, monitoring of the current state and automatic control actions.

### BACKGROUND ART

The following discussion is intended to facilitate an understanding of the invention. However, it should be appreciated that the discussion is not an acknowledgement or admission that any of the material referred to was published, known or part of the common general knowledge of the person skilled in the art in any jurisdiction as at the priority date of the application.

Presently process control automation systems are most often designed as a complete system with a system-wide self contained control problem to be solved by the system. In known systems, the complete system design is well characterised and downloaded to a control device such as a Programmable Logic Controller (PLC). Such a control solution does not easily allow for flexible change in the system or any dynamic interaction within the system, for example, if any of the devices that are controlled by the system are moved or changed in any way.

### DISCLOSURE OF THE INVENTION

According to an aspect of the present invention, there is provided a process control system provided in an environment and comprising control means and a multiplicity of devices coupled thereto, characterised in that the devices are provided in one or more sub-environments and have linked control actions with associated trigger conditions, and in that the control means is operable to control the devices in accordance with their linked control actions, and further characterised in that the environments and the devices located therein are organised in hierarchies and each device has an associated unique hierarchical identifier for an associated environment, the control means being operable to generate control actions for a device depending upon the associated hierarchical identifier.

Preferably, the control means is operable to generate the hierarchical identifier for a device depending upon the environment associated with the device and to monitor the environment of the device such that, if a change in environment is detected then the control means is operable to generate an updated hierarchical identifier in response to the detected change, and to generate any associated control actions.

Preferably, the system includes a visual display means, wherein the control means is operable to display the hierarchies on the display means.

Preferably, the control means is operable to use the hierarchical identifier to define dependencies between multiple devices and any associated trigger conditions, properties, or control actions.

Preferably, one or more of the devices are users of a system and the control means is operable to define the dependencies and/or properties between users and other of the multiplicity of the devices and properties of the other of the multiplicity of the devices.

In another aspect of the invention, there is provided a controller for a process control system provided in an environment and arranged for coupling to a multiplicity of devices provided in one or more sub-environments and having linked control actions with associated trigger conditions, characterised in that the controller is operable to: control the devices in accordance with their linked control actions; organise the environments and the devices located therein in hierarchies; associate a unique hierarchical environmental identifier for an associated environment to a device; and generate control actions for a device depending upon the associated hierarchical identifier.

Preferably, the controller is further operable to generate the hierarchical identifier for a device depending upon the environment associated with the device and to monitor the environment of the device such that, if a change in environment is detected then the controller is operable to generate an updated hierarchical identifier in response to the detected change, and to generate any associated control actions.

Preferably, the controller includes a visual display means, wherein the controller is operable to display the hierarchies on the display means.

Preferably, the controller is operable to use the hierarchical identifier to define dependencies between multiple devices and any associated trigger conditions, properties, or control actions.

Preferably, one or more of the devices are users of the process control system and the controller is operable to define the dependencies and/or properties between users and other of the multiplicity of the devices and properties of the other of the multiplicity of the devices.

In another aspect of the invention, there is provided a method for automation of a process control system provided in an environment and arranged for coupling to a multiplicity of devices provided in one or more sub-environments and having linked control actions with associated trigger conditions, characterised in that the method includes the steps of: controlling the devices in accordance with their linked control actions; organising the environments and the devices located therein in hierarchies; associating a unique hierarchical environmental identifier for an associated environment to a device; and generating control actions for a device depending upon the associated hierarchical identifier.

Preferably, the method includes the further steps of: generating the hierarchical identifier for a device depending upon the environment associated with the device; monitoring the environment of the device such that, if a change in environment is detected then an updated hierarchical identifier is generated in response to the detected change, and any associated control actions are generated.

Preferably, the method includes the step of displaying the hierarchies on a display means.

Preferably, the method includes the steps of defining dependencies between multiple devices and any associated trigger conditions, properties, or control actions using the hierarchical identifier.

Preferably, one or more of the devices are users of the process control system and the method includes the step of defining the dependencies and/or properties between users and other of the multiplicity of the devices and properties of the other of the multiplicity of the devices.

In yet another aspect of the present invention, there is provided a process control system provided in an environment and comprising control means and a multiplicity of devices coupled thereto, characterised in that the devices are provided in one or more sub-environments and the environments and the devices located therein are organised in hierarchies and each device has an associated unique hierarchical identifier for an associated environment, wherein one or more of the devices are users of a system and the control means is operable to define the dependencies and/or properties between users and other of the multiplicity of the devices and properties of the other of the multiplicity of the devices.

Preferably, the device properties include permissions, controls and features and the control means is operable, through the defined dependency between users and devices to define the properties available to each of the linked users.

Preferably, the properties include rights of control and/or access to the associated device.

Preferably, the control means is operable to determine if a device is added or removed from the system and to redefine dependencies between users and the added or removed device by associating the relevant identifiers.

Preferably, the control means is operable to generate a communication to users in response to a detected addition or removal of a device.

Preferably, the control means is operable to import and export data relating to the coupled devices.

Preferably, the control means includes display means, and the control means is operable to display the properties on the display.

In another aspect of the present invention, there is provided a controller for a process control system provided in an environment and having a multiplicity of devices coupled thereto, and provided in one or more sub-environments characterised in that the controller is operable to organise the environments and the devices located therein in hierarchies and associating a unique hierarchical environmental identifier with each device for an associated environment, wherein one or more of the devices are users of a system and the controller is operable to define the dependencies and/or properties between users and other of the multiplicity of the devices and properties of the other of the multiplicity of the devices.

Preferably, the device properties include permissions, controls and features and the controller is operable, through the defined dependency between users and devices to define the properties available to each of the linked users.

Preferably, the properties include rights of control and/or access to the associated device.

Preferably, the control means is operable to determine if a device is added or removed from the system and to redefine dependencies between users and the added or removed device by associating the relevant identifiers.

Preferably, the control means is operable to generate a communication to users in response to a detected addition or removal of a device.

Preferably, the controller is operable to import and export data relating to the coupled devices.

Preferably, the controller includes display means, and the controller is operable to display the properties on the display.

In a final aspect of the present invention, there is provided a method for automation of a process control system provided in an environment and having a multiplicity of devices coupled thereto, and provided in one or more sub-environments characterised in that the method includes the steps of: organising the environments and the devices located therein in hierarchies; and associating a unique hierarchical environmental identifier with each device for an associated environment; wherein one or more of the devices are users of a system and the method includes the further step of defining the dependencies and/or properties between users and other of the multiplicity of the devices and properties of the other of the multiplicity of the devices.

Preferably, the method includes defining the device properties to include permissions, controls and features and the method includes the step of defining the properties available to each of the linked users, through the defined dependency between users and devices.

Preferably, the properties include rights of control and/or access to the associated device.

Preferably, the method includes the step of determining if a device is added or removed from the system and to redefine dependencies between users and the added or removed device by associating the relevant identifiers.

Preferably, the method includes the step of generating a communication to users in response to a detected addition or removal of a device.

Preferably, the method includes the steps of importing and exporting data relating to the coupled devices.

Preferably, the method includes the step of displaying the properties on the display on display means.

Preferably, the device is a person or an inanimate device.

Thus, the present invention provides a process control system, a controller and a method for automation of the process control system, which is adapted to be dynamic and managed more flexibly and easily than is possible with existing known methods of process control and automation technology. Through this static and dynamic hierarchical organisation of the process control system, the manager can organise and construct a controlled, logged and monitored hierarchical automation environment which contains the device(s) or to which devices can be added, removed, reassigned and reconfigured manually or dynamically.

This contrasts with many known process control systems that look at the control system as a fixed relationship between devices defining a set of control equations that need to be solved.

It can be seen that the proposed system allows multiple users to share the use of devices and data in a way that increases utility and removes the necessity for people to have and control their own automation devices. The proposed scheme is less complex and costly and yet increases the utility of an automation system and decreases the cost of programming and implementation by sharing devices and data and improves communication and the transfer of knowledge between people.

### BRIEF DESCRIPTION OF THE DRAWINGS

The invention will now be described, by way of example only, with reference to the accompanying drawings of which:

FIG. 1 is a schematic illustration of a process control system in accordance with an aspect of the present invention; and

FIG. 2 is a schematic illustration of an example of an aquaculture environment having an automated process control system in accordance with an aspect of the present invention with a multiplicity of devices provided therein.

### BEST MODE(S) FOR CARRYING OUT THE INVENTION

What is proposed in the present invention is an alternative method of managing a process control system that allows for much more flexible change in a manner that is more flexible and sophisticated while being more congruent with the way that people think about their automation problems.

Broadly, the present invention relates to a process control system provided in an environment (and—where appropriate—sub-environments) that includes a number of different devices that are provided for a number of functions.

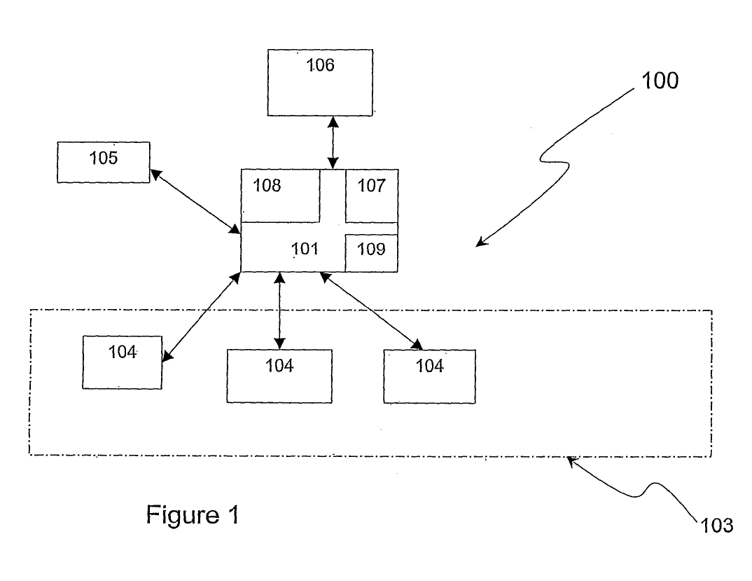

FIG. 1 illustrates an example of a process control system 100. The process control system 100 includes a controller 101—for example a computer or other suitable programmable controller—and process control equipment 103. The process control equipment 103 includes peripheral devices 104 such as sensors, actuators and transducers as may be appropriate, and which operate in response to signals from the controller 101, and which are also operable to provide data to the controller 101 as appropriate depending upon their function. In this way, the controller 101 is operable to control, operate and respond to the devices 104 as required to provide an automated system. The devices 104 may have trigger conditions linked to them which, when activated, cause the device 104 to function in accordance with predetermined control actions. The peripheral devices 104 are coupled to the controller 101 in any suitable way, for example through a known network wireless protocol, the Internet or an Ethernet network.

The use of process control for automation of processes is well known, and, as such, need not be described in any further detail herein, except as is relevant to the present invention.

The devices 104 are located in environments as required and are operable to communicate with the controller 101 in any suitable manner.

The controller 101, will typically be coupled to user interfaces such as a keyboard 105, and a visual display 106, with, for example, a touch screen. The controller 101 will also include a processor 107, and memory 108 (including one or more databases 109) as is well known to person skilled in the art. The controller 101 is programmed to enable the process control system 100 to be operable as will be described in more detail below.

Within the process control system 100 the environments and the devices 104 provided therein, are organised in hierarchies to assist the manager to manage and configure the devices as a process control system and to deliver flexible and useful control functions. In practice, this is implemented in the controller 101 as will be described in further detail below.

The devices 104 may have their control actions dependent on and ordered with other devices and their trigger conditions. Control actions may also depend upon the environment in which it is located.

Each device 104 has a hierarchical identifier associated therewith which defines the device in terms of its environment and sub-environments. This hierarchical identifier is generated and stored at the controller 101, and allows control sequences to be set up involving one or more devices by defining the dependencies between devices and their trigger conditions. Changes in the environment (and therefore in its identifier) can trigger control actions and/or a sequence of actions to be initiated under control of the controller 101. Along with control actions, information about the type of device and operational parameters and characteristics that it has can be linked to the hierarchical information and is stored in the controller 101. Configuration data for a device can include the location of the environment or device, a pictorial representation, calibration parameters, control sequences, trigger levels and dependencies on other devices. Examples of this include a picture of the device or the operational and calibration parameters that it uses to be read (if a sensor) or activated (if an actuator).

Each device 104 can be a physical device such as a sensor, switch or valve, or can be a virtual device modelled by part of a computing method and implemented in the controller 101. Such virtual devices offer greatly increased flexibility. For example, they can represent switches activated by a graphical picture on a touch screen or they can offer delay or timing functions. They can indicate a dependency on a logical set of conditions (either defined by device trigger conditions and dependencies on other devices, or by computer program logical statements) before operation or assessment of the device is initiated. They can also temporarily replace real devices for testing purposes. Such virtual devices can also be organised into a system of hierarchies and environments as with real devices.

Devices could also be people, animals or any other object—and the term should be construed accordingly. Devices may also be considered to be environments for other devices.

As mentioned above, the devices 104 are associated with hierarchically organised environments. Each environment may have stored with it the graphical or pictorial representations of the environment and the spatial separation, topological organisation and geographical location relative to the other environments in the hierarchy. While this information could be relative to the other environments and devices 104, it could also be absolute by using geographical coordinates.

Alternatively, the previous hierarchically organised devices 104 and their control information can be defined by another more conventional means such as by the interrogation of a separate database containing substantially the same information.

Further, the relationships between the hierarchies of devices 104 can be changed manually or dynamically and this in itself can trigger automation actions or new automation sequences.

The process control system 100 can also contain a ‘logged’ history of the past state of the devices 104 and can also allow monitoring of the present state of the system.

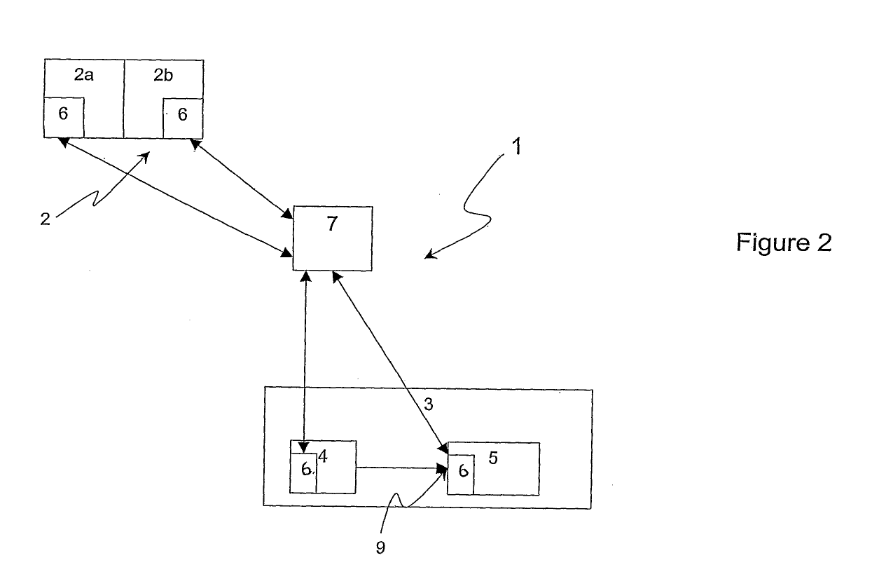

A specific example of the general features referred to above will now be described to further illustrate the invention. In this example, illustrated in FIG. 2, there is provided a process control system 1 in an aquaculture operation (Acme Fish Company) that contains an office building 2 and a production shed 3 at one of their properties. The production shed 3 contains six tanks 4, 5, one—a hatching tank 4—for hatching fish, and five—Grow-out tanks 5—for growing them. For clarity, only two tanks are shown in FIG. 2. Each tank includes a number of devices 6 such as an oxygenation pump, which includes a flow sensor inside the pump to indicate operation, an oxygen sensor, a temperature sensor, and a PH sensor. The tanks 4, 5 are connected by valves 9 which allow the fish to travel between them. Near the outlet of each valve 9 is an RFID transmitter (not shown) that can detect the passage of a fish and identify it and its location at that time. The production shed 3 also includes devices 6, such as four security sensors, four lights, and seven security cameras. All of these sensors, pumps, lights and cameras etc. constitute devices 6 which are all coupled to a controller 7 to send and receive signals thereto as appropriate. In FIG. 2, only a number of the devices 6 are illustrated for clarity.

The office 2 is split into a front and back office 2a and 2b. Each office 2a, 2b has a light and a security sensor, while the front office also includes a camera. These lights, security sensors and camera are also devices 6 within the context of this invention.

The system is described by a number of hierarchically organised environments and devices linked to those environments:

### Environment: Acme (Fish Farms)

Devices: All devices owned by Acme or located in its properties.

Environment: Property 1 (Sub environment to Acme)

The environmental identifier is Acme: Property 1:

Devices: 4 Security sensors, 4 Lights, 7 Cameras, 6 oxygen sensors, 6 Temperature Sensors, 5 RFID transmitters, 6 Fish valves, 6 pH Sensors, 6 Oxygenation Pumps, 6 Flow Sensors

Environment: Office Building (Sub environment to Property 1)

The environmental identifier is Acme: Property 1: Office

Devices: 2 Security sensors, 1 Camera, 2 Lights

Environment: Front Office (Sub environment to Office Building)

The environmental identifier is Acme: Property 1: Office: Front

Devices: Camera, Light, Security Sensor

Where each device is uniquely identified by its name and hierarchical environment for example:

Environment: Rear Office (Sub environment to Office Building)

The environmental identifier is Acme: Property 1: Office: Rear

Devices: Light, Security Sensor

Environment: (Production) Shed (Sub environment to Property 1)

The environmental identifier is Acme: Property 1: Shed

Devices: Light 1, Light 2, Security Sensor Front, Security Sensor Rear

Environment: Hatching Tank (Sub environment to Shed)

The environmental identifier is Acme: Property 1: Shed: Hatching Tank

Devices: Light, Camera, Oxygen Sensor, Temperature Sensor, pH Sensor, Oxygenation Pump, Flow Sensor, Fish Valves, camera

Environment: Grow-out Tank 1 (Sub environment to Shed)

The environmental identifier is Acme: Property 1: Shed: Grow-out Tank 1

Devices: Light, Oxygen Sensor, Temperature Sensor, pH Sensor, Oxygenation Pump, Flow Sensor, RFID Transmitter, camera

This last example can be repeated for the remaining four grow-out tanks.

It can be seen that each device is uniquely described by its name and the hierarchy of its environment.

In the case of the flow sensors they can be logically attached to the tank environments as shown.

Alternatively—because they are part of the pumps—the flow sensors can be considered as devices in a pump environment. That is, the device of the pump is an environment to which other devices can be attached. In this case the environment can be defined as Acme: Property 1: Shed: Grow-out Tank 1: Oxygenation Pump: and the device is a Flow Sensor.

Such a hierarchical scheme can be as arbitrarily deep as required.

Additionally, if each fish were fitted with an RFID tag, then the fish can be considered as an environment itself containing a device (RFID tag) with a unique serial number. In this case the environment would be Trout: RFID Tag: with device (#000100), where #000100 would be the serial number of the RFID. tag. And if it is known to be in grow-out tank 1: the environment would be Acme: Property 1: Shed: Grow-out Tank 1: Trout: RFID Tag: with the device as RFID tag #000100.

For convenience, if it can be assumed that the RFID tag represents a fish with an RFID tag so alternatively this might be shortened (for convenience) to the environment as Acme: Property 1: Shed: Grow-out Tank 1 with the device as RFID tag #000100.

The system 1 can, on the basis of control parameters within the process control system 1 that can be attached to each device 6 and/or each environment (or by another programmed control scheme) implement flexible control of the aquaculture setup.

For example, as the fish move through the tanks in response of the fish valves opening in response to a control method, their size and weight can be estimated by analysing pictures taken by the cameras and their location determined.

Dynamically their environment might change as a location change was detected. For example:

If the trout with RFID tag #000100 were to move into grow-out tank 1 and in doing so, this movement was detected by the RFID sensor located in the entrance to the first tank, the process control system 1 will note that the trout is in a new environment.

This dynamic association of a device with a new environment—and therefore a new environmental identifier—would act as a trigger for a specific control system change. For example, a different feeding cycle can be triggered for the fish. The movement of enough fish through the valves might reset the feed level to a lower amount and reset a counter which progressively increments feed based upon duration or a size estimation of the fish.

The environmental hierarchical identifier is able to be used to define the relationship—that is the dependency—between devices and the associated trigger conditions to enable the process control system 1 to cause devices to operate in response to changes in other devices—for example, and as referred to above, when a certain fish (a first device) moves from one environment to another then the fish has a changed environmental identifier which can be used by the process control system 1 (and in particular the controller 7) to determine that this change triggers an automatic feeding device (another device of the control system 1) to operate in accordance with a predetermined feeding cycle.

Additionally, GPS coordinates can be attached to devices and/or environments within the hierarchy. These GPS coordinates can be static (in the case of fixed environments or devices) or dynamic being the output from a GPS device connected to the system or within an environment (for example, a moving vehicle) or another device. The GPS device can be treated like any other device in the system.

It is easily appreciated that the proposed method provides a flexible method of control in this example that is superior to the known methods commonly applied in PLC's and other control systems. Further it can be readily appreciated that such a hierarchical control method is easier for people to manage as it relates to the way people think about devices in environments as devices are attached to logically organised environments that can be tied to geographic coordinates.

Further it is easily appreciated that the invention as described can be abstractly applied to many other conventional industrial control situations such as production lines and also for many other uses that are not currently served by automation. For example, while the example of a fish was given with an RFID tag as a device, equally a person might be an environment with a device such as a mobile phone or computer associated with them.

In another embodiment of the invention the process control system can be used to contact a person so that communication and intervention in a control process can be effectively managed. In some process control systems, it is necessary for operators or users to be able to be contacted for a variety of reasons.

In existing devices there exist fields within the system for putting contact information so that people can be contacted if required, for example by mobile phone, pager, or by email, in response to a problem, or to provide information. For example, one or more mobile phone numbers may be stored so that a Short Message Service (SMS) message may be sent out to a first phone number. If there is no response then a second mobile phone number may be called and so on.

A number of problems with this arise. Firstly, not all people will have all available communication devices and sometimes the devices might be shared between users. Secondly not all people may be near the particular devices so multiple devices may need to be tried, and thirdly several people may need to be informed by the process control system. Multiple contacts may also need to be made simultaneously eg email 3 people at once, or sequentially, eg contact Andrew initially, then, if there is no response in 10 minutes (eg using a virtual device that is a timer) then contact Bruce, and not all contact methods may be appropriate for each person for example contact Andrew by pager, and then if no answer in two minutes, call his home landline telephone. It can be seen that the permutations are many and for maximum utility to cover all possible wanted situations requires a general solution.

The proposed invention can easily accommodate this by:

1. Treating the person as a device (that can input and output responses manually) or as an environment for communication devices that allow communication with the person.

2. Treating the various communication devices as hierarchical devices.

3. Dynamically altering the contact method and order depending upon the location of individuals and devices.

To illustrate the last example, and using the process control system 1 of the previous embodiment, assume that if the aquaculture tank oxygenation stops, an operator must be urgently alerted. There may be many operators in a complex shift arrangement and if one cannot be contacted, a second or third must be. They may have different means of contact (for example a pager, mobile, computer (via email or instant message) or landline (voice or touch tone) and not all operators may have such devices. To add complexity, they may share a pager or mobile phone and hand this over as a shift changes.

Such information may have been conveniently already stored hierarchically in a database or directory so that it can be imported into the automation system or it might have been manually entered. For example the unique identifiers can be defined as:

### Environment:

Identifier—Acme: Technician: Property 1: Andrew:

Devices: Mobile:sms, Mobile:voice, Mobile: touch tone, Pager, Computer: Keyboard, Loudspeaker

Note that the mobile itself can be considered as an environment for the SMS, voice and touch tone devices and can be uniquely described by its phone number.

### Environment:

Identifier—Acme: Technician: Property 1: Bruce:

Devices: Mobile:sms, Mobile:voice, Mobile: touch tone, Pager, Computer: Keyboard, Loudspeaker

### Environment:

Identifier—Acme: Manager: Property 1: Colin:

Devices: Mobile:sms, Mobile:voice, Mobile: touch tone, Pager, Computer:Email, Computer:instant message, Loudspeaker

In this way people are considered as environments for devices (in this embodiment communication devices). Each device would have configuration and programming responses associated with it. It can be readily understood that by using previously described methods with these assignments and by writing appropriate ‘drivers’ for each type of device that very flexible controls and responses can be set up in any way that a user may desire.

For example, A(ndrew), B(ruce) and C(olin) might be growing fish and the oxygenation pump stops. A and B are on site for sixteen hours per day but no one is in attendance at night. The roster may cycle through making A, B, and C primarily responsible as the first night contact or may change weekly. During the day however, the other two individuals are likely to be near the site and should be informed of problems first. If, for example, A is paged (shared pager and all parties have the same pager record) but does not respond to the alarm within 10 minutes then B may be SMS'ed; however upon the problem occurring all have been emailed. The alert method may cycle through all three people and also take other action such as turning on a bottle of oxygen to prevent fish death if no response is received after trying all three people.

Using the unique identifiers above, the people were associated with the Property 1 environment meaning that their landline number would not be called as they are on site. Instead the loudspeaker device may be used as a first means to alert them. Alternatively as their environmental association changes by manual means (such as logging a change of shift or location) or automatic means (for example by using GPS or RFID and an appropriate sensor or transmitter carried by the person) the controller 7 is operable to determine when the identifier changes. For example it might call the landline of a second Acme property (Property 2) or the home landline number. For example if A was now at his residence then the environment is Acme: Technician: Residence: Bruce: and the devices are Mobile:sms, Mobile:voice, Mobile: touch tone, Pager, Landline: Touch tone, Landline: Voice.

The control action would change accordingly. Here the loudspeaker device is not appropriate as the person to be contacted is not on the site of Property 1, however the landline number is the determined device that is to be controlled to contact the appropriate person.

The proposed scheme can be simple to set up but can also have very flexible operation as may be needed by some people's work practices. Other less flexible schemes may contact people at the wrong times causing inconvenience or may take expensive remedial action (like turning on the oxygen bottle) before it is truly needed leading to further inconvenience and expense. Having the right type of convenient contact that does not false trigger can breed confidence in its use so that any alert is taken more seriously rather than being a system that ‘cries wolf’.

Further this layer of control can be pre configured for the operator so that a simpler interface can assist the user to set up common predefined behaviours manually or by the importation of a roster. The user can still configure more complex behaviour beyond the predefined solutions.

It is not difficult to abstract the present invention to many other common circumstances. For example the control actions could result from a person walking around the rooms of a house and being associated with different rooms (environments) to turn on and off devices like lights. In this embodiment, the person would be the device whose location within different environments would change depending upon the environment.

In a further embodiment of the invention a user/manager of the system manages and monitors the hierarchies by use of the visual display 106. Icons or pictures of the devices and environments can be displayed on the visual display 106, thus allowing the manager to graphically browse the hierarchies by clicking on the icon or picture of the device and environment displayed on the visual display 106—in the usual manner. The user can click through the environments displayed on the visual display 106 showing the current level of the environment and the devices 104 in that environment as well as their past or current states. This graphical representation can give access to all features and operations associated with the devices and environments including dynamic device and environmental associations and their control actions.

Further, devices are tied to meaningful, auditable and findable labels and that can be linked to geographic coordinates or locations that may change. The triggers and control information can be associated with each unique identifier such that different automation behaviour occurs should the device and environment associations or locations change. This adds simplicity in understanding automation behaviour in human terms as people better relate to devices and environments and their locations. By bringing simplicity, it enables at the same time a new level of complexity and sophistication to automation.

In yet another embodiment of the invention consider the aquaculture operation of FIG. 2 that is used for aquacultural research. The research facility uses the six tanks 4, 5 in the production shed 3—one for hatching fish, and five for growing them. Different experiments may be undertaken in the different tanks perhaps trialling the growth of different species of fish. The tanks 4, 5 may be provided with lights over all the tanks to simulate a day cycle. The system is described by:

### Environment: Acme (Fish Researchers)

Devices: All devices owned by Acme or located in its properties.

Environment: Property 2 (Sub environment to Acme)

The environmental identifier is Acme: Property 2:

Devices: 1 pan, tilt and zoom camera, 1 Air Temperature sensor, 4 Lights, 6 oxygen sensors, 6 Water Temperature Sensors, 6 pH Sensors, 6 salinity sensors, 6 Oxygenation Pumps, 6 Flow Sensors and other devices that might be on the property for security or other control purposes.

Environment: (Research) Shed (Sub environment to Property 2)

The environmental identifier is Acme: Property 2: Shed:

Devices: 1 pan, tilt and zoom camera, 1 Air Temperature sensor, 4 Lights, 6 oxygen sensors, 6 Water Temperature Sensors, 6 pH Sensors, 6 salinity sensors, 6 Oxygenation Pumps, 6 Flow Sensors

Environment: Hatching Tank (Sub environment to Shed)

The environmental identifier is Acme: Property 2: Shed: Hatching Tank:

Devices: Oxygen Sensor, Temperature Sensor, pH Sensor, Oxygenation Pump, Flow Sensor

Environment: Grow-out Tank 1 (Sub environment to Shed)

The environmental identifier is Acme: Property 2: Shed: Grow-out Tank 1:

Devices: Light, Oxygen Sensor, Temperature Sensor, pH Sensor, Oxygenation Pump, Flow Sensor, RFID Transmitter, camera

This last example can be repeated for the remaining four grow-out tanks. It can be seen that each device is uniquely described by its name and the hierarchy of its environment.

Such a hierarchical scheme can be as arbitrarily deep as required.

In this embodiment, the hierarchical organisation of the environments and the devices provided therein can be used to allow different people to access devices (and any data generated by them) for control and automation purposes. Control and automation purposes include monitoring i.e. determining the present state or condition, logging i.e. determining past states and controlling i.e. automatic responses to past and present conditions.

In this case the devices are each ‘owned’ by a person or, if desirable, jointly by a number of people. An owner can confer rights such as the right to change device characteristics, to delete the device or to grant read access (in the case of inputs or devices that contain inputs) or write access (in the case of an output or devices that contain outputs). As with other functions of the process control system 1, this is implemented at the controller 7.

An owner could choose to ‘advertise’ to other people that the device is available for use or may choose to keep the device hidden. Rights could be managed on an individual basis or people might be grouped together for convenience or a combination of these methods could be used.

The rights for each user are associated with each unique hierarchical device or environment identifier as appropriate such that they may be individually listed by association with the identifier and stored in the controller 7, or alternatively linked to a separate database to manage the access of people to the devices 6.

By following this method, the process control system 1 is operable to link permissions and control actions to the hierarchical identifiers to enable control and automation of the devices.

Consider multiple people who may need access to the information from the facility. Multiple researchers A(ndrew), B(ruce) and C(harlie) are conducting experiments. D(onald) is the facility manager and E(dward) is the facility assistant manager and G(reg) is a commercial aquaculturalist.

A, B and C may each have their own grow out tank that they are responsible for and use for their experiments but may share the hatching tank as this is required for a lesser period of use.

In a conventional PLC system, the entire system is often programmed as a control system according to a system wide view of the control problem to be solved. This does not suit a research environment well as experimentation means that the control problem changes frequently.

A more flexible system is needed to conduct experiments. Moreover the data and control functions of the facility are shared and managed by different people. Not all people will have all devices 6 but there are benefits in sharing some devices. For instance the air temperature device may be installed and owned by D, but calibrated by E. A, B and C all may need access to the data from the air temperature sensor for their experimental data. Each of A, B and C would typically be given ownership and control of the devices in each of their grow-out tanks but would need at least temporary access to the devices in the hatchery tank while their fish were hatching. They may not have the job or knowledge of calibrating any of these devices and this may be the job of E and he may have the rights to do this. A, B and C wish to use the pan, tilt and zoom camera to focus on their tanks at intermittent intervals to monitor their fish as a part of their experiments so this is a shared device. A and B may be running experiments that are on the same species and may wish to share their data. C may be running a confidential experiment and may not wish to share his data with A or B. The lights may be globally controlled to simulate day and night and the times that they are turned on and off may be useful data for A, B and C.

A system of properties such as permissions, controls and features to make the system more flexible and useful for multiple users is provided. In this embodiment the defined relationship between the users and the devices is the link between the devices (and their properties) and the users. These properties use the hierarchical identifiers to link the devices, and their properties, to one or more of the multiple users. All of this is implemented at the controller 7.

Firstly the installer of a sensor can make themselves or another user the owner of that sensor with special rights to calibrate, read its data, control its state, configure it or remove it. These rights can be individually assigned to individuals uniquely or in any combination and permutation to them jointly or in common. This can be done when the device is first installed or changed because an experiment ends meaning that a device is more usefully reassigned or a new individual is granted access to the control system.

From the example given, it can be seen that there is benefit in the common devices being managed by one person, probably D. However, E may be the only person trained to properly calibrate some of the devices and is best given calibration rights over some or all of the devices. A may wish to share the logged data with B but not the live current data—only logged data. The control system enables the granted rights over devices via common authentication means such as a password or some other kind of software or hardware key so that these rights and functions are enabled only for the right people.

The calibration and maintenance schedule for each device is best if it is information that is associated with each device. This information could be entered manually when the device is added or can be automatically entered in configuration data from the manufacturer. The system can warn the calibrator (for example E) in advance of impending calibration required or if it is overdue. Users (A, B and C) can also be flagged if a device has not had its proper calibration schedule maintained so that they know that their data or control application may be affected.

It may be beneficial to assign the rights for users based upon individual devices or it may be more convenient and useful to assign and manage the rights based upon the environment that the devices are associated with (for example, all devices in tank 1), or it may be beneficial to do this by the type of device (for example, all oxygen probes). An alternative to this would be to group devices and/or environments into projects or experiments and grant rights appropriately. Hierarchical identifiers would be generated by the controller 7 accordingly, and rights to change the environment configuration parameters can be assigned with the relevant devices 6 that the project contains or the configuration information could be assigned to a separate individual by linking with the hierarchical identifier.

The configuration data for the device can include the location of the environment or device, pictorial representation, calibration parameters, control sequences, trigger levels and dependencies on other devices. Associated with devices and environments are user comments. User comments present a log of the changes and experimental notes that are marked in a laboratory notebook style. That is, once notes are entered, they may not be deleted to comply with scientific audit requirements. Notes are attributed to the authenticated operator that enters them and can be attached to devices and environments. Notes can be viewed and retrieved by user, device and environment just as any logged data can.

The pictorial representation can be an icon, picture or diagram of the devices or environments to be displayed while users are using the controller. These can be imported or drawn using an application native to the process control system 1.

Another feature is that different pictures can be enabled for individual users and users that have rights to the devices. Further, the icon, picture or diagram of the device can change to indicate the rights that are enabled for that environment or device. Equally the colour or shape of the icon, picture or diagram may change depending upon the state or trigger levels of the device.

It can also be seen that it may be useful for different users to have different pictures or icons associated with different devices, other parameters can also be provided on a per user basis. Consider for example the air temperature sensor that can be capable of sampling air temperature every second. A may require a reading every second for his experiment while B may require a reading every minute and C every thirty seconds. A may be concerned if the temperature (trigger level) is at 10 degrees Celsius while B may be concerned at 15 degrees Celsius. Such common parameters can be stored with the device and permission given for each user to modify such common parameters as per their needs.

Once B has completed his research, he may wish to share the data with others live (in real time) or from the logged archive of past data. Others can include colleagues or the commercial aquaculturalist G. B may grant G access to B so that he can access the past data directly from the logged data in the control system. Permissions would prevent G from modifying or altering data, devices and environments and also not allow him to look at the data from A or C's experiments.

A second level of utility may be achieved by importing or exporting device, environment and experimental set ups between users and systems. For example, if B develops a good process for growing trout, the control set up can be exported directly to the aquaculturalist (G) who has a similar control system and wishes to grow trout. Here, it would be allowed for G to take the environments and devices directly or to intelligently merge the setup into his environment and control setup by substituting devices and environments. Similarly a manufacturer of a device can provide the data to allow easy substitution for other parts and the easy addition of sensors and actuators.

Such imported and exported data can be in the form of a computer file that is transferred manually, or it may be sent by electronic communications means such as email for manual installation or automatically sent and installed by a special protocol that is set up between controllers in order to facilitate this. For example, a simple way of doing this can be through a TCP/IP communication port.

It would be beneficial for exported data to be accompanied by a logic diagram showing the interrelationships between devices and environments in the exported control scheme. Such a logic diagram could be separate and viewable prior to the importation of the control data or it can be viewable through the system controller software as part of its normal operation after importation.

Finally, if devices and environments are shared between users there are special considerations when adding, changing or deleting users, devices and environments. If D was to remove the common air temperature sensor (and had permission rights to do so) but A, B, and C depend on this information for their successful experiment then experimental integrity could be compromised. To get around this several schemes are used. Firstly, if a device is to be removed or reassigned to a new environment by D, then A, B and C can be automatically informed by email or another communication means of the change. At another level of sophistication, A, B and C may not have ownership or change rights for a device but the data provided by it might still be critical to their work. They may have a veto right on the removal enforced by the system until their experimental work is completed.

If a new device is added to an environment or system and is available for general or restricted use, then its services can be offered to the users in order that they can take advantage of the data or controls that are provided. This could be communicated via email or another communication means or its services can be advertised in a list of unused devices.

Further, if a person owning or using a device is removed from the system then this needs to be managed by the system. In the first instance, the ownership and rights could be added to an existing persons list of rights or assigned to a new person. Further if the devices are unassigned upon the removal of a person, then they might be offered to existing people in the same manner as the services of a new device described above.

Similar usage can be extrapolated for multiple users of commercial and research establishments in many fields of use. The approach is generally applicable to a wide variety of automation and control uses beyond the aquaculture example given.

Similarly, while the example is given here of a single enterprise, the notion of sharing of devices and permissions can be across any control network that spans multiple enterprises, locations or the world.

It will be readily understood to persons skilled in the art that the term ‘process’ can be construed to include any process or operation in any context and should not be limited, for example, to industrial or commercial contexts. Devices can be any object or person and can include, for example, people and animals as well as inanimate objects. The term environment is to be construed as any aggregate of things, conditions or surrounds and can be for example a person, spatial region, or object, and could be real or virtual.

Throughout the specification, unless the context requires otherwise, the word “comprise” or variations such as “comprises” or “comprising”, will be understood to imply the inclusion of a stated integer or group of integers but not the exclusion of any other integer or group of integers.

What is claimed is:

1. A process control system comprising a controller and process control equipment coupled thereto, the process control equipment comprising one or more peripheral devices provided in one or more environments, the environments being arranged in a variable hierarchy, the process control equipment being operable in response to signals from the controller and to provide data to the controller such that the controller is operable to control, operate and respond to the peripheral devices to thereby provide an automated process control system, the peripheral devices having predetermined functions and trigger conditions associated therewith, and whereby the controller is operable to define dependencies between peripheral devices and trigger conditions to set up predetermined control sequences for the process control equipment, and wherein the peripheral devices have an associated hierarchical identifier dependent upon the environment, and the level of the hierarchy, in which it is located, an updated associated variable hierarchical identifier being generated and stored by the controller in response to a change in an environment, the controller being further operable to initiate a control sequence for one or more of the peripheral devices in response to the generation of an updated identifier.

2. A process control system according to claim 1, wherein the controller is operable to store information regarding the process control equipment, and operational parameters, the information and parameters being linked to the hierarchical identifier.

3. A process control system according to claim 1, wherein the controller is operable to store information related to each environment in which the process control equipment is located.

4. A process control system according to claim 3, further comprising a visual display unit, the controller being operable to display the environmental information and the hierarchies graphically on the visual display unit, whereby a user can browse through the displayed hierarchies.

5. A process control system according to claim 1, wherein the peripheral devices are virtual devices modeled and implemented by the controller.

6. A process control system according to claim 1, wherein the controller is operable to set up the dependencies between peripheral devices and trigger conditions under control of a user.

7. A process control system according to claim 1, wherein one or more of the peripheral devices are users of a system and the controller is operable to define the dependencies and/or properties between users and other of the multiplicity of the peripheral devices and properties of the other of the multiplicity of the peripheral devices.

8. A process control system according to claim 7, wherein the properties comprise permissions, controls and features and the controller is operable, through the defined dependency between users and peripheral devices to define the properties available to each of the linked users.

9. A process control system according to claim 8, wherein the properties comprise rights of control and/or access to the associated peripheral device.

10. A process control system according to claim 7, wherein the controller is operable to determine if a peripheral device is added or removed from the system and to redefine dependencies between users and the added or removed peripheral device by associating the relevant identifiers.

11. A process control system according to claim 10, wherein the controller is operable to generate a communication to users in response to a detected addition or removal of a peripheral device.

12. A process control system according to claim 7, wherein the controller is operable to import and export data relating to the coupled peripheral devices.

13. A controller for a process control system, the process control system comprising process control equipment coupled to the controller, the process control equipment comprising one or more peripheral devices provided in one or more environments, the environments being arranged in a variable hierarchy, the process control equipment being operable in response to signals from the controller and to provide data to the controller such that the controller is operable to control, operate and respond to the peripheral devices to thereby provide an automated process control system, the peripheral devices having predetermined functions and trigger conditions associated therewith, and whereby the controller is operable to define dependencies between peripheral devices and trigger conditions to set up predetermined control sequences for the process control equipment, and wherein the peripheral devices have an associated hierarchical identifier dependent upon the environment, and the level of the hierarchy, in which it is located, an updated associated variable hierarchical identifier being generated and stored by the controller in response to a change in an environment, the controller being further operable to initiate a control sequence for one or more of the peripheral devices in response to the generation of an updated identifier.

14. A controller according to claim 13, wherein the controller is operable to store information regarding the process control equipment, and operational parameters, the information and parameters being linked to the hierarchical identifier.

15. A controller according to claim 13, wherein the controller is operable to store information related to each environment in which the process control equipment is located.

16. A controller according to claim 15, wherein the controller is operable to display the environmental information and the hierarchies graphically on a visual display unit coupled to the controller, whereby a user can browse through the displayed hierarchies.

17. A controller according to claim 13, wherein the peripheral devices are virtual devices modelled and implemented by the controller.

18. A controller according to claim 13, wherein the controller is operable to set up the dependencies between peripheral devices and trigger conditions under control of a user.

19. A controller according to claim 13, wherein one or more of the peripheral devices are users of a system and the controller is operable to define the dependencies and/or properties between users and other of the multiplicity of the peripheral devices and properties of the other of the multiplicity of the peripheral devices.

20. A controller according to claim 19, wherein the properties comprise permissions, controls and features and the controller is operable, through the defined dependency between users and peripheral devices to define the properties available to each of the linked users.

21. A controller according to claim 20, wherein the properties comprise rights of control and/or access to the associated peripheral device.

22. A controller according to claim 19, wherein the controller is operable to determine if a peripheral device is added or removed from the system and to redefine dependencies between users and the added or removed peripheral device by associating the relevant identifiers.

23. A controller according to claim 22, wherein the controller is operable to generate a communication to users in response to a detected addition or removal of a peripheral device.

24. A controller according to claim 19, wherein the controller is operable to import and export data relating to the coupled peripheral devices.

25. A method for automation of a process control system, the process control system comprising a controller and process control equipment coupled to the controller, the process control equipment comprising one or more peripheral devices provided in one or more environments, the environments being arranged in a variable hierarchy, the process control equipment being operable in response to signals from the controller and to provide data to the controller such that the controller is operable to control, operate and respond to the peripheral devices to thereby provide an automated process control system, the peripheral devices having predetermined functions and trigger conditions associated therewith, the method comprising:
defining dependencies between peripheral devices and trigger conditions to set up predetermined control sequences for the process control equipment; associating an hierarchical identifier with each peripheral device dependent upon the environment, and the level of the hierarchy, in which it is located;
updating the associated variable hierarchical identifier at the controller and storing said hierarchical identifier therein in response to a change in an environment; and
initiating a control sequence for one or more of the peripheral devices under control of the controller in response to the generation of an updated identifier.

26. A method according to claim 25, further comprising storing information regarding the process control equipment, and operational parameters, the information and parameters being linked to the hierarchical identifier.

27. A method according to claim 25, further comprising storing information related to each environment in which the process control equipment is located.

28. A method according to claim 27, further comprising displaying the environmental information and the hierarchies graphically on a visual display unit of the process control system, whereby a user can browse through the displayed hierarchies.

29. A method according to claim 25, further comprising modelling and implementing virtual devices as part of the process control equipment.

30. A method according to claim 25, wherein one or more of the peripheral devices are users of a system and the method comprises defining the dependencies and/or properties between users and other of the multiplicity of the peripheral devices and properties of the other of the multiplicity of the peripheral devices.

31. A method according to claim 30, wherein the method comprises defining the properties to comprise permissions, controls and features and the method comprises defining the properties available to each of the linked users, through the defined dependency between users and peripheral devices.

32. A method according to claim 31, wherein the properties comprise rights of control and/or access to the associated peripheral device.

33. A method according to claim 30, comprising determining if a peripheral device is added or removed from the system and to redefine dependencies between users and the added or removed peripheral device by associating the relevant identifiers.

34. A method according to claim 33, comprising generating a communication to users in response to a detected addition or removal of a peripheral device.

35. A method according to claim 33, comprising importing and exporting data relating to the coupled peripheral devices.

36. A process control system according to claim 1, wherein the peripheral device is a person or an inanimate device.

37. A controller according to claim 13, wherein the peripheral device is a person or an inanimate device.

38. A method according to claim 25, wherein the peripheral device is a person or an inanimate device.

39-41. (canceled)
